(19) United States
(12) Patent Application Publication
(10) Pub. No.: US 2012/0025752 A1
(43) Pub. Date: Feb. 2, 2012

(54) BATTERY CHARGER

(75) Inventors: Ross Teggatz, McKinney, TX (US); Eric Blackall, Plano, TX (US); Brett Smith, McKinney, TX (US); Wayne Chen, Plano, TX (US); Jonathan Knight, Osaka (JP)

(73) Assignee: TRIUNE IP LLC, Richardson, TX (US)

(21) Appl. No.: 13/193,407

(22) Filed: Jul. 28, 2011

Related U.S. Application Data
(60) Provisional application No. 61/368,318, filed on Jul. 28, 2010.

(51) Int. Cl. H02J 7/00

(52) U.S. Cl. 320/101; 320/107; 320/150; 320/139; 320/137

(57) ABSTRACT

The invention provides advances in the arts with useful and novel battery charger circuits and methods providing improved energy conservation, harvesting, and utilization efficiencies.

### PRIORITY ENTITLEMENT

This application is entitled to priority based on Provisional Patent Application Ser. No. 61/368,318 filed on Jul. 28, 2010, which is incorporated herein for all purposes by this reference. This application and the Provisional Patent Application have at least one common inventor.

### TECHNICAL FIELD

The invention relates to battery charging circuits, methods, and systems for controlling battery charging. More particularly, the invention relates to apparatus and techniques for charging batteries in a controlled manner in order to efficiently utilize available energy and avoid overcharging.

### BACKGROUND OF THE INVENTION

Battery charging system requirements vary based on the type of batteries to be charged. One common battery charging problem is ensuring the avoidance of overcharging. With lead-acid and lithium-ion batteries overcharging can be avoided simply by setting a maximum charge voltage, also called a termination voltage, at which charging is terminated. This approach cannot be used with some batteries which do not have a clearly defined or readily detectable termination voltage. For example, NiCad (nickel cadmium) and NiMH (nickel metal hydride) batteries are problematic, as such batteries do not have a clearly defined termination voltage. Another problem, particularly in energy harvesting applications, is obtaining and storing the maximum amount power from available energy inputs. Due to the foregoing and other problems, improved integrated charge control circuits and systems would be useful and advantageous contributions to the applicable arts.

### SUMMARY OF THE INVENTION

In carrying out the principles of the present invention, in accordance with preferred embodiments, the invention provides advances in the arts with useful and novel battery charging circuitry having the capability of controlling charging to prevent overcharging while efficiently using available charging energy. Variations in the practice of the invention are possible and exemplary preferred embodiments are illustrated and described. All possible variations within the scope of the invention cannot, and need not, be shown. It should be understood that the invention may be used with various power sources, battery types and configurations, and alternative circuit topologies and components.

According to one aspect of the invention, in an example of a preferred embodiment, a battery charging circuit has a regulator connected to an input node. An intermediate storage element is connected to the regulator and to an output node. Battery charging control circuitry controls the regulator such that the circuit operates at a level tracking the maximum power point. The battery charging control circuitry enables the system to store input power at the intermediate storage element or to transmit power to the output node, depending upon the available input power.

According to another aspect of the invention, in a preferred embodiment of the battery charger described, it is implemented as a single microchip device.

According to another aspect of the invention, a preferred embodiment of a battery charging circuit described also includes one or more photovoltaic solar cells for providing input power.

According to another aspect of the invention, a preferred embodiment of a battery charging circuit described includes one or more nickel-based batteries, such as NiMH or NiCad batteries.

According to another aspect of the invention, a preferred embodiment of an integrated maximum power point tracking battery charging circuit has an input node for receiving input power and a boost regulator connected with the input node. An intermediate storage element is connected with the boost regulator and an output node, and with battery charging control circuitry. The system is adapted to selectably boost, store, or transmit power to the output depending upon the level of available input power.

According to another aspect of the invention, in a preferred embodiment, a method for battery charging includes a step of receiving a variable source of power at an input node. The input power is regulated for maximum power point tracking. In the event input power is at a level sufficient to charge an associated battery, charging power is provided directly to the battery. In the event input power is at a level insufficient to charge the battery, an intermediate storage element is charged. Subsequently, when the charge in the intermediate storage element is sufficient, the intermediate storage element is used to providing charging power to the battery.

The invention has advantages including but not limited to providing one or more of the following features, facilitating the harvesting and conservation of renewable energy, prevention of battery damage from overcharging, improved efficiency, and reduced costs. These and other advantageous, features, and benefits of the invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the description and drawings in which:

FIG. 1 is a graphical representation of an exemplary battery charging profile for use with the battery charger of the invention;

FIG. 2 is a simplified schematic block diagram of an example of a battery charger according to a preferred embodiment of the invention; and

FIG. 3 is a simplified schematic block diagram depicting an example of a preferred embodiment of a battery charger according to the invention.

References in the detailed description correspond to like references in the various drawings unless otherwise noted. Descriptive and directional terms used in the written description such as front, back, top, bottom, upper, side, et cetera, refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DESCRIPTION OF PREFERRED EMBODIMENTS

The making and using of various specific exemplary embodiments of the invention are discussed herein. It should be appreciated that the systems and methods described and shown exemplify inventive concepts which can be embodied in a wide variety of specific contexts. It should be understood that the invention may be practiced in various applications and embodiments without altering the principles of the invention. For purposes of clarity, detailed descriptions of functions, components, and systems familiar to those skilled in the applicable arts are not included. In general, the invention provides battery charger circuitry for controlling charging of batteries such as, for example, NiCad and NiMH batteries. The invention is described in the context of representative example embodiments. Although variations in the details of the embodiments are possible, each has advantages over the prior art.

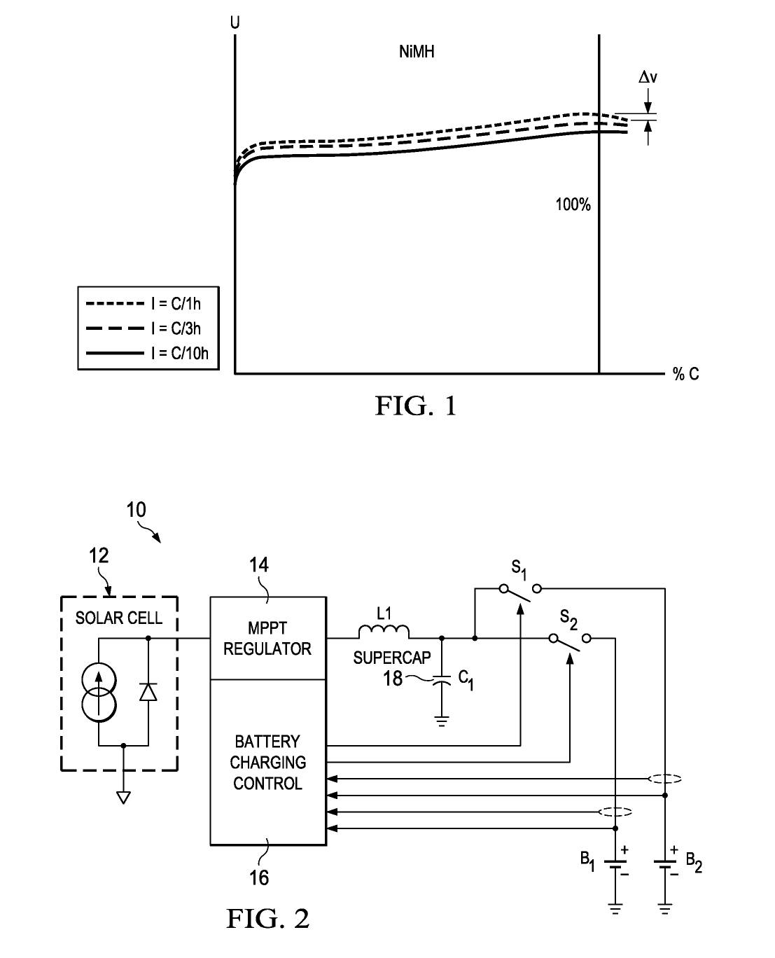

Rechargeable batteries often require specific charge sequencing in order to maintain their effectiveness and avoid permanent damage. Common rechargeable battery chemistries include lead-acid, Lithium-Ion, and Nickel-based batteries. The different types of batteries have different charging profiles. For example, it has been determined that the charging profile of a Nickel Metal Hydride (NiMH) battery is relatively complex. Referring to FIG. 1, a NiMH battery is preferably initially charged through a constant current of 1 CmA. The change in battery voltage and temperature are monitored, and when they exceed selected thresholds, e.g., >10 mV decline, indicated as negative delta-V, and two degrees (centigrade) per minute temperature increase, the charge current is reduced to a trickle current, e.g., about 0.05 CmA. Because of the complexity of this charging profile, existing battery charging technology generally includes external dedicated charger and/or microcontroller units to ensure proper battery charging. The negative delta-V bump shown in FIG. 1 is indicative of end-of-charge, and is less pronounced in NiMH than NiCad. End-of-charge is also temperature dependent in some nickel-based batteries. Further complicating matters, new NiMH batteries can exhibit bumps in the curve early in the cycle, particularly when cold. Additionally, NiMH batteries are sensitive to damage from overcharging when the charge rate is over C/10. However, with low levels of current, the negative delta-V bump is not always easily detected. It has also been determined that applications in which the charger power is supplied by a solar panel, wind energy harvesting generator, or other energy source for which the power output is variable, there is the added complication that at times there may be a limited amount of power available to charge the battery. At times when the current available to charge the battery is low, detection of the negative delta-V bump is more difficult than is otherwise the case in applications with a more consistent energy input source.

The invention provides a battery charger circuit having the capability of controlling charging for various battery charging profiles. The integrated maximum power point tracking (MPPT) charging circuit includes regulator circuitry adapted to the use of available power from low and variable intensity sources such as solar cells. Power harvested from solar cells is inherently variable and intermittent. The power output from a solar array typically is influenced by many factors which change over time including illumination intensity, panel temperature, and operating point. Maximum power generation occurs as the panel transitions from constant current to constant voltage operation. In order to maximize the power generated from any solar panel, the panel voltage and/or current are monitored and adjusted to operate at the optimal power point, by the technique of Maximum Power Point Tracking (MPPT). In preferred embodiments, a startup circuit block may also be included to ensure that the battery charger can effectively start from low supply voltages. Preferably, the battery charger is implemented in the form of a single chip which can operate on voltage as low as about 0.3V. The battery charger dynamically adapts to changes in system losses or component aging. The battery charger circuit dynamically adjusts the load seen by the power source, e.g., a solar panel, increasing energy efficiency and enhancing energy harvesting yield by ensuring that the panel operates at its maximum power point. At the same time, the voltage at the output of the battery charger circuit is matched to that of the particular battery configuration.

FIG. 2 shows a simple schematic block diagram of an example of a preferred embodiment of a battery charger system 10 according to the invention. The solar-powered battery charger system 10 in this example is associated with a solar cell 12, or an array of solar cells, also referred to as photovoltaic (PV) cells. Of course, other or additional power sources may also be used without departure from the principles of the invention. A maximum power point tracking (MPPT) regulator 14 is coupled to receive a power input from the solar cell 12. Battery charging control circuitry 16 is preferably associated with the regulator 14. As shown, an inductor L1, intermediate storage element 18, and switches S1, S2, complete the necessary connections with a battery or array of batteries, represented by batteries B1 and B2, suitable for recharging, such as NiCad and NiMH batteries. Although the batteries B1, B2, are shown connected for charging in a parallel configuration in this example, batteries may alternatively be connected in a series configuration as well.

In operation, the solar cell 12 has a tendency to provide variable amounts of power to the system 10 depending upon the conditions of the operating environment. In a scenario in which the solar cell 12 supplies sufficient power to charge the batteries B1, B2, the MPPT regulator 14 preferably maximizes the amount power transferred from the solar cell 12 to the batteries B1, B2.

In an alternative operational scenario, the solar cell 12 is at times unable to provide sufficient power to charge the batteries B1, B2 directly. The intermediate storage element 18 is preferably charged with the available power. In FIG. 2, a super capacitor C1 is shown as an intermediate storage element 18. Other charge storage elements, or combinations of charge storage elements, may also be used, such as lead-acid, Li-Ion, or Li-Poly batteries, for example. The intermediate storage element 18 is monitored by the battery charging control circuitry 16. In this scenario, the MPPT regulator 14 is preferably used to provide the maximum amount of power from the solar cell 12 to the intermediate storage element 18. Once sufficient charge is stored on the intermediate storage element 18, the switches S1, S2 are regulated to provide charge current to the batteries B1, B2. The batteries B1, B2 are preferably charged with high current pulses, the length of which correspond to the capacity of the intermediate storage element 18 so as to permit the charging control circuitry 16 to adequately detect the occurrence of the negative delta-V transition on the batteries B1, B2. During charging, the voltage on the batteries B1, B2 is preferably monitored and recorded by the charger control circuitry 16 for comparison during each current charging cycle to be used in identifying the negative delta-V transition.

There are many possible variations possible in implementing the principles of the invention. It should be appreciated by those skilled in the art that there are several approaches that may be used to control the transfer of charge to the batteries within the scope of the invention. Charging current may be pulsed to a level suitable for measuring at the battery to detect whether charging should be ended or decreased. The current may be pulsed higher than 1 C, or pulsed higher than the average charging current monitored over a period of time. In either case, a short duration of high current is used to provide a reading to identify the negative delta-V. The voltage on the intermediate storage element may also be regulated in order to maximize the efficiency of charging. The voltage on the intermediate storage element(s) may be regulated to minimize the voltage difference across the switches when connected to batteries at the output, thereby reducing power losses in the system as a whole. It is contemplated that, as there are numerous types of intermediate storage elements, as well as different battery chemistries and charging profiles, the MPPT regulator and battery charging control circuitry may be implemented with microprocessor controls allowing for flexibility in how a given implementation is ultimately used. The MPPT regulator may be configured as a switched-mode regulator, such as a charge pump, buck, boost, or buck/boost configuration, or as a linear regulator such as a shunt or low-dropout series type. The objective for the MPPT regulator is to maximize the output power of the solar cell to the extent practical. For multiple batteries, the system may preferably be adapted to monitor voltage, current, and temperature on each individual battery. Temperature rise may be monitored and used in conjunction with the current pulsing and delta-V detection parameters for determining the appropriate termination of charging. Monitored temperature changes may also be used to manage the heating of batteries by charge-cycling through each battery for time periods based on temperature changes. Fault checking may also be implemented as to each individual battery, with each battery preferably disconnectable from the system in the case of a detected fault. In another variation in keeping with the principles of the invention, batteries associated with the battery charger circuit may be discharged from time to time in order to condition the batteries to remove memory effects. The battery charging controller may be configured to cause the charging of the intermediate storage element from the discharging of the associated batteries.

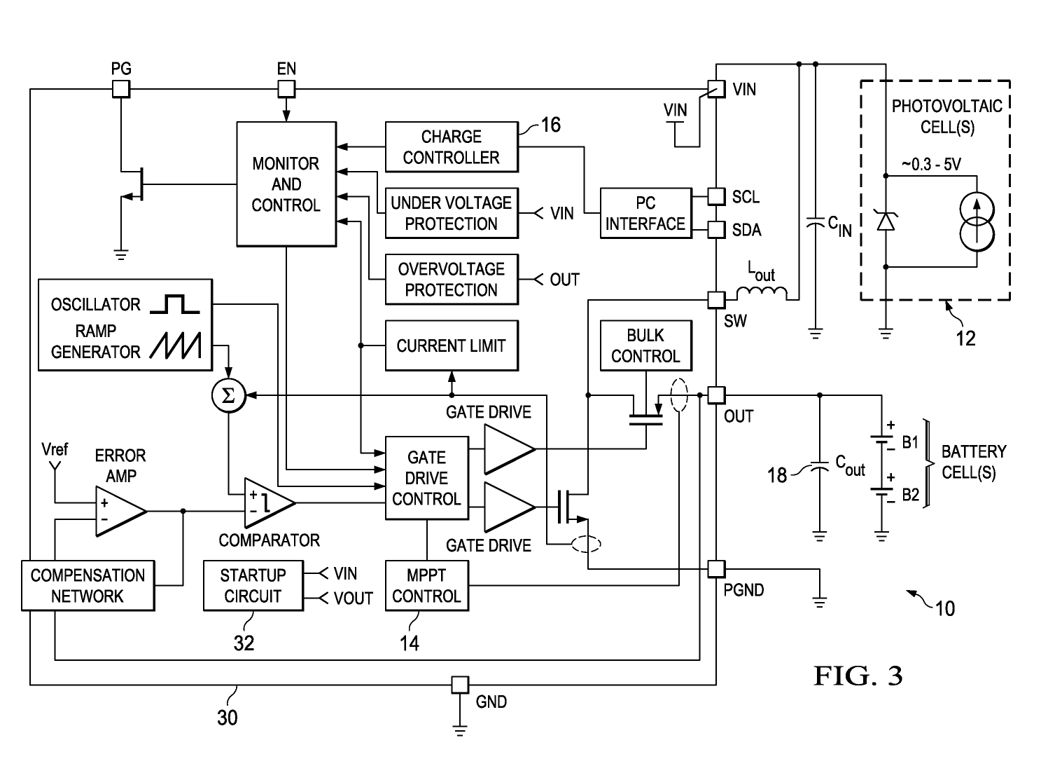

An alternative view of an integrated battery charger circuit 10 is depicted in the schematic block diagram of FIG. 3. Preferably, the circuit 10 is provided with an available power source 12, such as a PV array, and batteries B for charging. An MPPT control 14 augments the DC-DC boost converter circuit 30, preferably designed for operating on voltages as low as approximately 0.3V. Separate startup circuitry 32 is preferably included in order to ensure that the system 10 is capable of starting when supplied with a low-voltage input supplied by the power source 12, a micro-solar panel for example. It should be appreciated that in low-voltage applications, the circuit 30 shown may preferably be implemented using low-Vt or natural CMOS transistors in order to maximize headroom under low-voltage operating conditions. Optionally, the battery charger control circuitry 30 uses an electrically erasable/programmable memory, e.g., EEPROM, configurable through an I2C digital serial interface. This programmability may be used by those skilled in the art to tailor the charging profile to match the requirements of a particular battery stack. Additionally, the battery charger circuit 10 may be matched to charging profiles for virtually any battery chemistry or storage medium by associating it with additional internal configuration register blocks, redefining the I2C sub-addresses, and including additional internal memory, status monitoring, and fault control circuitry.

Preferred embodiments of the invention are implemented in an integrated single chip device, thereby providing advantages in terms of lower manufacturing costs compared to discrete charger and MCU implementations. The integration of MPP tracking and voltage DC-DC converter described is readily scalable. The system may be implemented in sizes from micro-solar to large, off-grid infrastructure applications, such as powering pico-cell and femto-cell cellular base stations. Providing compact and efficient solar panel operating power control, the technology may also be used to increase the system efficiency of higher wattage residential and industrial solar power generation applications by ensuring each individual solar cell operates at its Maximum Power Point.

The circuits, systems and methods of the invention provide one or more advantages including but not limited to, efficient use of energy resources, low cost energy harvesting, a battery charger scalable to various portable and larger applications, and reduced production costs. While the invention has been described with reference to certain illustrative embodiments, those described herein are not intended to be construed in a limiting sense. For example, variations or combinations of steps or components and topologies in the embodiments shown and described may be used in particular cases without departure from the invention. Although the presently preferred embodiments are described herein in terms of particular examples, modifications and combinations of the illustrative embodiments as well as other advantages and embodiments of the invention will be apparent to persons skilled in the arts upon reference to the drawings, description, and claims.

We claim:

1. A battery charging circuit comprising:
an input node for receiving input power;
a regulator coupled with the input node;
an intermediate storage element coupled with the regulator and an output node;
battery charging control circuitry operably coupled for controlling the regulator and intermediate storage element, whereby the charging control circuitry controls the regulator such that it operates at a maximum power point tracking level; and wherein
input power may selectably be stored at the intermediate storage element, and transmitted to the output node.

2. The battery charging circuit according to claim 1 wherein the regulator further comprises a boost regulator.

3. The battery charging circuit according to claim 1 wherein the battery charging control circuitry further comprises a circuit for monitoring output node voltage.

4. The battery charging circuit according to claim 1 wherein the battery charging control circuitry further comprises a circuit for monitoring output node current.

5. The battery charging circuit according to claim 1 wherein the battery charging control circuitry further comprises microprocessor controls.

6. The battery charging circuit according to claim 1 wherein the circuit comprises a single microchip device.

7. The battery charging circuit according to claim 1 further comprising a solar cell operably coupled to the input node.

8. The battery charging circuit according to claim 1 further comprising a battery operably coupled to the output node.

9. The battery charging circuit according to claim 1 further comprising a NiMH battery operably coupled to the output node.

10. The battery charging circuit according to claim 1 further comprising a NiCad battery operably coupled to the output node.

11. The battery charging circuit according to claim 1 further comprising:
a battery operably coupled to the output node; and
wherein the battery charging control circuitry further comprises a circuit for monitoring battery temperature.

12. An integrated maximum power point tracking battery charging circuit comprising:
an input node for receiving input power;
a boost regulator coupled with the input node;
an intermediate storage element coupled with the boost regulator and an output node; and
battery charging control circuitry operably coupled for controlling the boost regulator and intermediate storage element; whereby
input power may selectably be boosted, stored at the intermediate storage element, and transmitted to the output node.

13. The battery charging circuit according to claim 12 wherein the battery charging control circuitry further comprises a circuit for monitoring output node voltage.

14. The battery charging circuit according to claim 12 wherein the battery charging control circuitry further comprises a circuit for monitoring output node current.

15. The battery charging circuit according to claim 12 wherein the battery charging control circuitry further comprises microprocessor controls.

16. The battery charging circuit according to claim 12 wherein the circuit comprises a single microchip device.

17. The battery charging circuit according to claim 12 further comprising a solar cell operably coupled to the input node.

18. The battery charging circuit according to claim 12 further comprising a NiMH battery operably coupled to the output node.

19. The battery charging circuit according to claim 12 further comprising a NiMH battery operably coupled to the output node.

20. The battery charging circuit according to claim 12 further comprising a NiCad battery operably coupled to the output node.

21. The battery charging circuit according to claim 12 further comprising:
a battery operably coupled to the output node; and
wherein the battery charging control circuitry further comprises a circuit for monitoring battery temperature.

22. A method for battery charging comprising the steps of:
receiving a variable source of power at an input node;
regulating the power received at the input node for maximum power point tracking; wherein
when input power at a level sufficient to charge an associated battery is detected, providing charging power to the battery; and
when input power at a level insufficient to charge an associated battery is detected, charging power is transmitted to an intermediate storage element; and subsequently,
when charge at a level sufficient to charge an associated battery is detected in the intermediate storage element, providing charging power to the battery.

23. The method for battery charging according to claim 22 wherein the step of transmitting charging power to the battery further comprises pulsing current provided to the battery.

24. The method for battery charging according to claim 22 wherein the step of transmitting charging power to the battery further comprises pulsing current provided to the battery at a level higher than the average of the current level provided to the battery over a selected time period.

25. The method for battery charging according to claim 22 wherein the step of transmitting charging power to the battery further comprises pulsing current provided to the battery at a level higher than the 1 C level.
